(19) United States
(12) Patent Application Publication
(10) Pub. No.: US 2008/0236405 A1
(43) Pub. Date: Oct. 2, 2008

(54) Heat detecting device and cooking apparatus using the same

(75) Inventors: Young Jun Lee, Seoul (KR); Seung Jo Baek, Gwangmyeong-si (KR); Byeong Wook Park, Gwangmyeong-si (KR); Hee Suk Roh, Incheon (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-ku (KR)

(21) Appl. No.: 12/003,485

(22) Filed: Dec. 26, 2007

(30) Foreign Application Priority Data
Mar. 28, 2007 (KR) 10-2007-0030173
Mar. 28, 2007 (KR) 10-2007-0030174

(51) Int. Cl. A47J 27/62

(52) U.S. Cl. 99/331

(57) ABSTRACT

A heat detecting device and a cooking apparatus using the same, in which the operation of a heating unit is appropriately controlled according to the presence or absence and/or type of cooking container (e.g., pan or pot) on the cooking apparatus. When there is no cooking container on the cooking apparatus, the duty cycle of the heat source is reduced, thereby preventing unnecessary operation of the heat source. Accordingly, power consumption is reduced. On the other hand, when there is a cooking container on the cooking appliance, the duty cycle of the heat source is increased, thereby making faster more efficient cooking possible.

### BACKGROUND

The Embodiments described herein relate to a temperature detecting device, which detects heat transferred from the outside, and a cooking apparatus, which controls a heat source using the temperature detecting device.

Cooking apparatuses are appliances that heat and cook food. In particular, a cook top is an appliance that cooks food using a heat generated by heating a cooking container put on a plate. The cook top is also called a hot plate or a hob. The use of cook tops has increased in recent years.

Related art cook tops generally include a plurality of heating units under the plate. A thermostat is provided inside the heating units to prevent overheating. The thermostat detects heat generated from the heating units and is switched at a predetermined temperature to turn on/off the heating units. In this way, the thermostat regulates the temperature of the plate.

In such a cook top, however, the thermostat is configured to mechanically operate at a predetermined temperature. Therefore, the temperature of the plate is not appropriately regulated as a function of load (i.e. the presence or absence of a cooking container or the type of cooking container) applied to the plate. In other words, the heat source is configured to operate at a predetermined duty cycle, regardless of the presence or absence and type of load. The duty cycle is defined by a unit on-time ratio of the heat source and expressed as Tₒₙ/(Tₒₙ+T_{off}), where Tₒₙ and T_{off} represent the on time and an off time of the heat source, respectively. In addition, the heat sensitivity of the thermostat is degraded because it operates mechanically.

### SUMMARY

Described herein are exemplary embodiments that provide among other things, heat detecting devices and cooking apparatuses using the same, wherein the operation of the heating unit can be appropriately controlled according to the load on the plate.

In the Embodiments described herein, the temperature of a heating unit or the plate can be detected electrically and sensitively.

In one embodiment, a heat detecting device for a cooking appliance includes a detecting unit and a supporting unit. The detecting unit includes a temperature sensor capable of responding to changes in heat generated from by a heat source and the temperature sensor is arranged such that heat generated from the heat source is directly transferred to the temperature sensor. The supporting unit is configured for supporting the detecting unit.

In another embodiment, a cooking apparatus includes a heat source; a plate above the heat source, the plate configured to receive a cooking container; and a heat detecting unit having a temperature sensor capable of responding to changes in heat generated by the heat source, the temperature sensor arranged such that the heat generated from the heat source is directly transferred from the heat source to the temperature sensor.

In further another embodiment, a cooking apparatus includes a heat source, a cooking surface and a control unit. The cooking apparatus further includes a means for detecting a first amount of heat generated by the heat source; a means for detecting a second amount of heat generated by the cooking surface; and a means for controlling the heat source based on the detected first and second amounts of heat.

In still further another embodiment, a method of controlling a cooking appliance that includes a heat source, a cooking surface and a control unit. The method includes detecting a first amount of heat generated by the heat source; detecting a second amount of heat generated by the cooking surface; and controlling the heat source based on the detected first and second amounts of heat.

Further details of the exemplary embodiments are set forth in the accompanying drawings and the description below. Other features will also be apparent from the description and drawings, and from the claims.

### BRIEF DESCRIPTION OF THE DRAWINGS

The Embodiments can be understood more fully from the following detailed description in conjunction with the accompanying drawings.

FIG. 1 is an exploded perspective view illustrating a first embodiment of a cooking apparatus with a ceramic plate.

FIG. 2 is an assembled perspective view of a heating unit and a heat detecting device.

FIG. 3 is a partial sectional view of the cooking apparatus shown in FIG. 1.

FIG. 4 is a perspective view of the heat detecting device shown in FIG. 2.

FIG. 5 is an exploded perspective view of the heat detecting device shown in FIG. 4.

FIG. 6 is a bottom view illustrating an embodiment of the heat detecting unit shown in FIG. 4.

FIG. 7 is a partial sectional view illustrating heat transfer in such a state that where a cooking container is not present on the cooking apparatus.

FIG. 8 is a partial sectional view illustrating heat transfer in such a state that where a cooking container is present on the cooking apparatus.

FIG. 9 is a partial sectional view illustrating another exemplary embodiment of a detecting unit.

### DETAILED DESCRIPTION OF THE EMBODIMENTS

A heat detecting device and a cooking apparatus using the same will be described below in detail in accordance with exemplary embodiments with reference to the accompanying drawings.

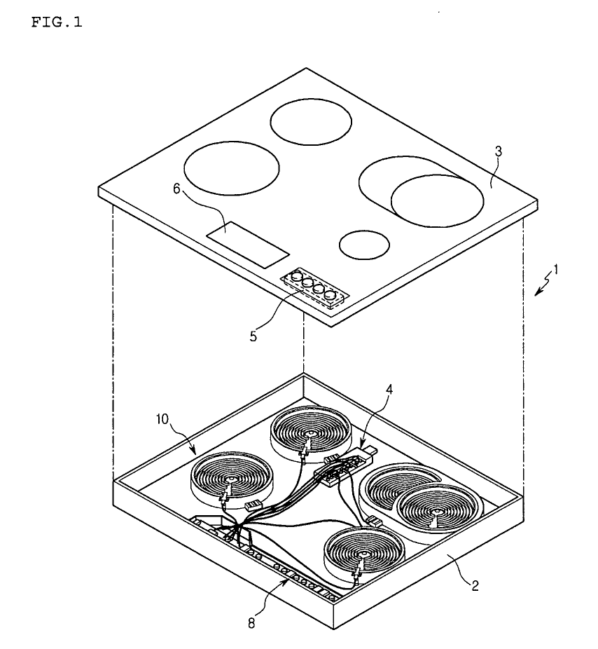

Referring to FIGS. 1, 2, and 3, the cooking apparatus 1 includes a main body 2 and a ceramic plate 3. The main body 2 receives at least one heating unit 10, and the ceramic plate 3 is provided above the main body 2.

The main body 2 defines the outer appearance of the cooking apparatus 1. A power supply 4, a control unit 8, and at least one heating unit 10 are provided inside the main body 2.

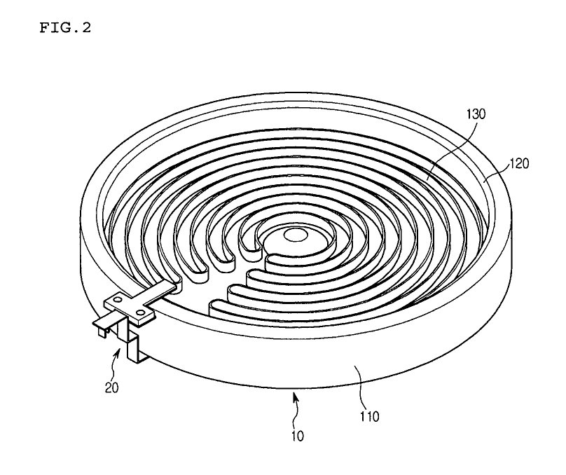

The heating unit 10 includes a casing 110, an insulator 120, provided inside the casing 110, and a heat source 130 also provided inside the casing 110. The heat source 130 may include a coil-shaped electrical resistance heating element, as shown in FIG. 2, however, but there is no limitation other types of heat source 130 are possible. For example, an electrical induction heating element may be used.

A heat detecting device 20 is connected to the heating unit 10 to detect heat associated with at least the heat source 130. The temperature detecting device 20 detects the heat transferred from at least the heat source 130, and sends a corresponding signal to the control unit 8. The control unit 8 determines the temperature based on the corresponding signal and then controls the operation of the heating unit 10 according to the temperature.

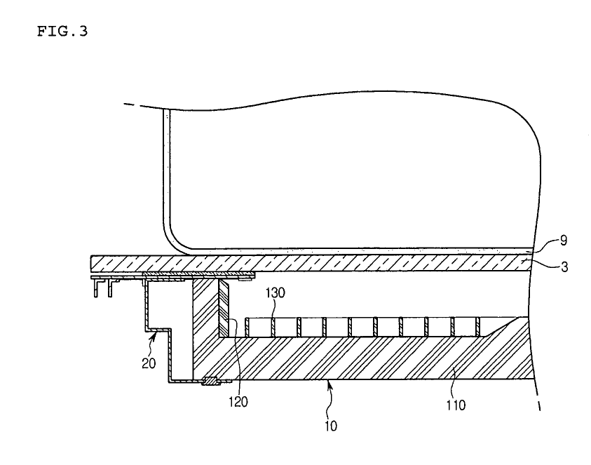

In FIG. 3, a cooking container 9 is present on the ceramic plate 3. A control panel 5 and a display unit 6 are provided on a frontal top surface of the ceramic plate 3 (see FIG. 1). The control panel 5 is used to control the cooking operation of the cooking apparatus 1, and the display unit 6 displays the operating state of the heating cooking apparatus 1.

The operation of the cooking apparatus 1 will be briefly described below. When cooking food with the cooking apparatus 1, the cooking container 9 containing food is put on the ceramic plate 3 and the operation of the cooking apparatus 1 is started. When the cooking apparatus 1 starts to operate, the heating unit 10 begins to operate. Some of the heat generated from the heating unit 10 is transferred directly to the cooking container 9, and some is transferred through the ceramic plate 3 to the cooking container 9. The food in the cooking container 9 is then cooked by the heat transferred in this manner.

During cooking, the heat detecting device 20 detects the heat from at least the heat source 130, wherein the heat source 130 is appropriately operated by use of the control unit 8 according to the information signal generated by the heat detection device 20.

The control unit 8 may include a microprocessor that performs control operations based on the temperature derived from the amount of heat detected by the heat detecting device 20. The control unit 8 may have or is associated with a memory that has, stored therein, information used by the microprocessor for control operations.

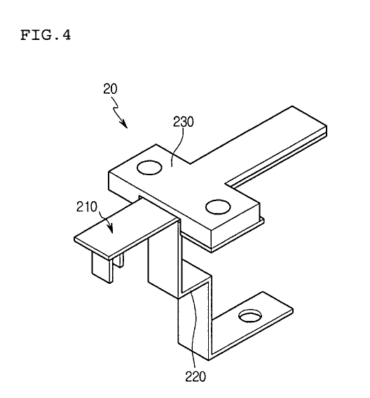

The structure of the heat detecting device 20 will now be described below in detail. Referring to FIGS. 4 to 6, a heat detecting device 20 is provided for each heating unit 10. As shown in FIG. 2, the heat detecting device 20 may be connected to one side of the heating unit 10.

The heat detecting apparatus 20 includes a detecting unit 210, a supporting unit 220, and a transferring member 230. The detecting unit 210 electrically detects heat. The supporting unit 220 supports the detecting unit 210 and connects the heat detecting device 20 to the corresponding heating unit 10. The transferring member 230 is disposed on the detecting unit 210 to transfer the heat of the ceramic plate 3 to the detecting unit 210.

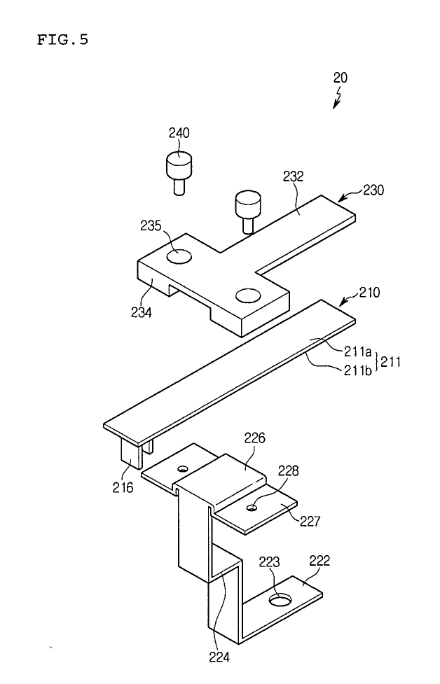

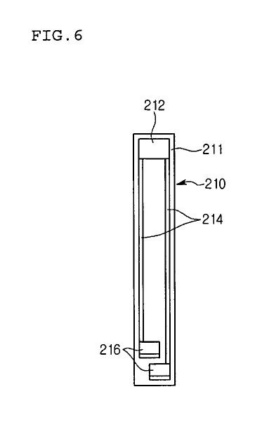

Referring now to FIGS. 5 and 6, the detecting unit 210 includes a substrate 211 formed of ceramic or other insulating materials. The substrate 211 has a top surface 211a and a bottom surface 211b. A temperature sensor 212 is provided at one end of the bottom surface 211b of the substrate 211.

The temperature sensor 212 is printed on the bottom surface 211b of the substrate 211. Examples of the temperature sensor 212 include a negative temperature coefficient (NTC) type sensor and a positive temperature coefficient (PTC) type sensor. The NTC type sensor has a resistance that decreases with increasing temperature, and the PTC type sensor has a resistance that increases with increasing temperature.

The temperature sensor 212 indicates a change in temperature in the form of a change in resistance. The control unit 8, and more specifically, the microprocessor, determines temperature based on the change in resistance using a predetermined circuit.

When the temperature detecting device 20 is connected to the heating unit 10, the temperature sensor 212 is exposed to the heating unit 10. In at least one exemplary embodiment, the temperature sensor 212 is opposite the heat source 130. That is, the temperature sensor 212 is arranged so that it faces the heat source 130. However, in other embodiments, the temperature sensor 212 is exposed to the heat source 130 without facing the heat source 130. In either case, when the heat source 130 operates, heat generated from the heat source 130 is directly radiated to the temperature sensor 212. In other words, the temperature sensor 212 directly detects the heat radiated from the heat source 130. Therefore, the temperature sensor 212 can more accurately detect heat generated by the heat source 130, and the control unit 8, including the aforementioned microprocessor, can more accurately determine temperature and, in turn, control the operation of the heat source 130.

A pair of terminals 216 is provided, for example, on the bottom surface 211b of the substrate 211. The terminals 216 are electrically connected to the control unit 8. The terminals 216 and the temperature sensor 212 are electrically connected by a pair of conductors 214. In this exemplary embodiment, the terminals 216, the conductors 214, and the temperature sensor 212 are provided on the bottom surface 211b of the detecting unit 210 although other configurations are possible. The conductors 214 may be formed of a material equal or similar to that of the temperature sensor 212.

The supporting unit 220 connects the heat detecting device 20 to the heating unit 10 and supports the detecting unit 210 at a predetermined height. The supporting unit 220 may be formed of an elastic metal.

The supporting unit 220 may include a bottom portion 222, as shown in FIG. 5, for example, a middle portion 224 extending upward from one end of the bottom portion 222 at a predetermined height, and a top portion 226 extending from the middle portion 224 in the same direction as the bottom portion 222.

More specifically, in this exemplary embodiment, the bottom portion 222 of the supporting unit 220 is connected to a bottom surface of the heating unit 10. In addition, at least one connecting hole 223 through which a connecting member (not shown) passes is formed in the bottom portion of the 222.

The middle portion 224 of the supporting unit 220 is bent multiple times and has a height substantially equal to the heat source 130.

The top portion 226 of the supporting unit 220 has a width substantially equal to that of the detecting unit 210, so that at least a portion of the detecting unit 210 is mounted on the top portion 226 of the supporting unit 220.

Coupling tabs 227 are provided on both sides of the top portion 226 of the supporting unit 220. Coupling tabs 227 connect the transferring member 230 to the supporting unit 220. In other words, the coupling tabs 227 extend downward from both sides of the top portion 226 by a predetermined length and then extend in a horizontal direction by a predetermined length. Thus, there is a height difference between the top portion 226 and the coupling tabs 227, as shown, for example, in FIG. 5.

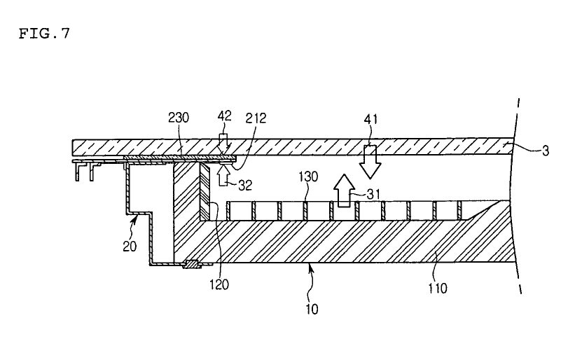

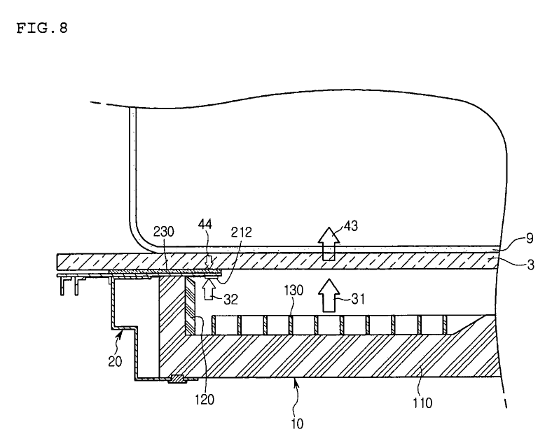

Referring now to FIGS. 7 and 8, the top surface of the transferring member 230 is, in this exemplary embodiment, in contact with the bottom surface of the ceramic plate 3. The transferring member 230 is disposed on the detecting unit 210 to transfer heat from the ceramic plate 3 to the detecting unit 210. Hence, the detecting unit 210 directly detects heat generated from the heat source 130, and indirectly detects heat from the ceramic plate 3 through the transferring member 230. The transferring member 230 may be formed of a material having high heat conductivity, for example, but not limited to aluminum.

The heat from the ceramic plate 3, which is transferred to the detecting unit 210 through the transferring member 230, changes depending on the load applied to the ceramic plate 3. Therefore, the temperature that is derived by the microprocessor changes depending on load. Because the temperature changes based on the heat transferred from the ceramic plate 3, the operation of the heating unit 110 can be appropriately controlled, at least in part, by accounting for the presence or absence of the load applied to the ceramic plate 3.

The load will be described below, in detail, and how the presence or absence of a load affects the heat source control process. Herein, when a cooking container 9 is on the ceramic plate 3, then there is no load being applied to the ceramic plate 3. When a cooking container 9 is on the ceramic plate 3, then there is a load applied to the ceramic plate 3. A change of load means that there has been a change in the type or kind of the cooking container 9, or food in the cooking container 9.

As shown, for example, in FIG. 5, the transferring member 230 has a width substantially equal to that of the detecting unit 210 and includes a cover 232 and a coupling portion. The cover 232 covers a portion of the top surface of the detecting unit 210, and the coupling portion 234 connects the transferring member 230 to the supporting unit 220.

The thickness of the coupling portion 234 may be greater than that of the cover 230. Therefore, when the transferring member 230 is connected to the coupling tabs 227, the coupling portion 234 surrounds the detecting unit 210 and the top portion 226 of the supporting unit 220. In this exemplary embodiment, the detecting unit 210 cannot move forward or backward and left or right.

The coupling tabs 227 have coupling holes 228 and the coupling portion 234 also has coupling holes 235. Coupling members 240 are inserted into the coupling holes 228 and 235 to connect the transferring member 230 to the supporting member 220.

When the heat source 130 is operating, the temperature sensor 212 of the heat detecting device 20 outputs a resistance value (i.e., an electrical signal reflecting the resistance value associated with the temperature sensor 212) based on heat. The microprocessor in control unit 8 then determines a temperature value based on the resistance value, or a change thereof, using a predetermined circuit.

The control unit 8 turns off the heat source 130 when the temperature reaches a first reference temperature. Thereafter, the temperature, as determined by the micro processor, decreases. The heat source 130 is again turned on when the temperature, as determined by the micro processor, reaches a second reference temperature lower than the first reference temperature. During the operation of the heat source 130, the control unit 8 continuously turns on and off the heat source 130 in this manner based on the amount of heat detected by the heat detecting device 20 and the temperature derived therefrom. In this exemplary embodiment, the operation of the heat source 130 is controlled so that the temperature derived by the micro processor based on the heat detected by the heat detecting device 20 is maintained in a range between the first and second reference temperatures. It will be understood that the duty cycle will be a relatively large value when the on time of the heat source 130 is long, and the duty cycle will be relatively small when the on time of the heat source 130 is short.

In FIGS. 7 and 8, heat transferred from the heat source 130 and the ceramic plate 3 are indicated by arrows, wherein a large arrow represents a relatively large amount of heat transfer and wherein a smaller arrow represents a relatively small amount of heat transfer. Referring more specifically to FIG. 7, when the heat source 130 operates without a cooking container 9 on the ceramic plate 3, some of the heat 31 generated from the heat source 130 is directly transferred to the ceramic plate 3 and some of the heat 32 is directly transferred to the temperature sensor 212. In addition, some of the heat 41 transferred to the ceramic plate 3 is transferred to the heating unit or the heat source, while some of the heat 42 is transferred from the temperature sensor 212. As mentioned above, the heat 42 transferred from the ceramic plate 3 to the temperature sensor 212 is transferred through the transferring member 230.

Accordingly, when a cooking container 9 is not on the ceramic plate 3, the ceramic plate 3 retains the heat 31 transferred from the heat source 130 and transfers the heats 41 and 42 to the transferring member 230 and the heating unit 10. In other words, most of the heat transferred to the ceramic plate 3 is transferred to the temperature sensor 212 or the heating unit 10. Hence, the temperature derived based on the heat detected by the heat detecting device 20, when the heat source 130 is turned on, rapidly increases to reach the first reference temperature. When the temperature rapidly increases, the amount of time required for the temperature, as determined by the micro processor based on the amount of heat detected by heat detecting device 20, to reach the first reference temperature is relatively short. This means that the on time for the heat source 130 is relatively short.

The ceramic plate 3 has a corresponding critical temperature the critical temperature represents a temperature above which the actual temperature of the ceramic plate 3 should not exceed. It will be understood that the first reference temperature is less than the critical temperature.

When the temperature, as determined by the microprocessor, reaches the first reference temperature, the heat source 130 is turned off. When the heat source 130 is turned off, the temperature slowly decreases until it reaches the second reference temperature. The reason the temperature slowly decreases is because the heat detecting device 20 is continuously supplied with heat from the ceramic plate 3. When the temperature slowly decreases, the amount of time required for the temperature to reach the second reference temperature is relatively long. This means that the off time of the heat source 130 is relatively long.

When the detected temperature reaches the second reference temperature, the heat source 130 is again turned on so that the temperature, as determined by the microprocessor, rapidly reaches the first reference temperature. Thus, the duty cycle (i.e., the unit on-time ratio) of the heat source 130 is reduced because the on time of the heat source 130 is relatively short whereas the off time is relatively long. This reduced duty cycle minimizes the operation time of the heat source 130 when the cooking container 9 is not on the ceramic plate 3, thereby reducing unnecessary power consumption.

In the aforementioned situation, where the cooking container 9 is not on the ceramic plate 3, the control unit 8 controls the heat source 130 such that the duty cycle of the heat source 130 is reduced. It will also be apparent that the operation of the heat source 130 can be maintained at the reduced duty cycle when the heat source 130 is operated with the same power.

Referring now to FIG. 8, when the heat source 130 is operated when a cooking container 9 is on the ceramic plate 3, some of heat 31 generated from the heat source 130 is directly transferred to the ceramic plate 3 and some of the heat 32 is directly transferred to the temperature sensor 212. On the other hand, a small amount of heat 44 is transferred from the ceramic plate 3 to the temperature sensor 212, whereas a relatively greater amount of heat 43 is transferred to the cooking container 9. Because most of the heat transferred to the ceramic plate 3 from the heat source 130 is transferred to the cooking container 9, the temperature, as determined by the microprocessor based on the amount of heat detected by the heat detecting device 20, slowly increases towards the first reference temperature, as compared to the aforementioned situation where there was no cooking container on the ceramic plate 3.

When the temperature slowly increases, the amount of time required for the temperature, as determined by the microprocessor, to reach the first reference temperature is relatively long. This means that the on time for the heat source 130 is relatively long.

The heat source 130 is turned off when the temperature, as detected by the microprocessor, reaches the first reference temperature. Thereafter, the temperature decreases relatively fast towards the second reference temperature. When the temperature decreases relatively fast, the amount of time required for the temperature, as determined by the microprocessor, to reach the second reference temperature is relatively short. This means that the off time for the heat source 130 is relatively short. When the temperature, as determined by the microprocessor, reaches the second reference temperature, the heat source 130 is turned on so that the temperature again increases relatively slowly towards the first reference temperature.

The duty cycle (i.e., the unit on-time ratio) of the heat source 130 is relatively large in this instance because the on time of the heat source 130 is relatively long and its off time is relatively short. The increase in the duty cycle of the heat source 130 when the cooking container 9 is on the ceramic plate 3 reflects the fact that the heat generated from the heat source 130 is continuously and effectively transferred to the cooking container 9. Hence, speed cooking is possible. Accordingly, in this situation, the heat source 130 is controlled such that the duty cycle is increased when the cooking container 9 is on the ceramic plate 3.

In the aforementioned exemplary embodiment, heat and, in turn, the temperature are electrically detected using the heat detecting device 20. In addition, temperature is determined based not only on the heat generated by the heat source 130, but also the heat emitted by the ceramic plate 3. Hence, a high-power heat source can be used and food can be cooked more quickly and efficiently.

In contrast, where the temperature of the heat source is mechanically detected using a thermostat, the duty cycle of the heat source is constantly maintained, regardless of the presence or absence of a cooking container. In this situation, when a high-power heat source is used, and only the internal temperature of the heating unit is taken into consideration, the thermostat is turned off early so that the duty cycle is reduced. In this case, the heat generated from the high-power heat source is not efficiently transferred to the cooking container.

Again, however, in the exemplary embodiment described above, when the heat and, therefore, the temperature is electrically detected and the cooking container (i.e., the load) applied to the ceramic plate is detected and taken into consideration most of heat generated from the high-power heat source is transferred to the cooking container and, therefore, the temperature determined by the microprocessor slowly increases. Hence, the duty cycle of the heat source can be controlled and maintained like the use of the low-power heat source, thereby making speed cooking possible.

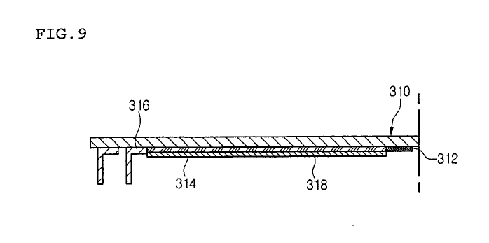

FIG. 9 is a partial sectional view illustrating a second exemplary embodiment of a heat detecting unit. As shown, the detecting unit 310 includes a temperature sensor 312, a conductor 314, and a terminal 316. In the following description, the same reference numerals are used to refer to the same parts that have been already described. More specifically, a ceramic protection member 318 is provided under the conductor 314.

The protection member 318 prevents the conductor 314 from being damaged during the assembling process of the heat detecting device 20. The protection member 318 may not cover the region where the temperature sensor 212 is formed so that the heat generated by the heat source 130 can be directly detected by the temperature sensor 212.

In addition, the protection member 318 prevents any inadvertent electrical connection between the supporting unit 220 and the conductor 314, both of which are formed of metal.

In the above-described exemplary embodiments, the temperature sensor directly detects the heat transferred from the heat source, so that the temperature can be determined more accurately. Further, since the heat from the ceramic plate is transferred to the detecting unit through the transferring member, the temperature sensor can also detect heat from the ceramic plate in addition to the heat generated by the heat source. Hence, the duty cycle of the heat source can be adaptively controlled based on the load applied to (i.e., a cooking container) the ceramic plate. When a load is not present on the ceramic plate, the duty cycle of the heat source is reduced, thereby preventing unnecessary operation of the heat source. Consequently, the power consumption is reduced. When a load is present on the ceramic plate, the duty cycle of the heat source is increased, thereby making speed cooking possible. Moreover, a high-power heat source can be used, which also facilitates speed cooking.

Although the present invention has been described with reference to a number of illustrative embodiments, it will be understood that numerous other modifications are conceivable and within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heat detecting device for a cooking appliance, the device comprising:
a detecting unit having a temperature sensor capable of responding to changes in heat generated from by a heat source, the temperature sensor arranged such that heat generated from the heat source is directly transferred to the temperature sensor; and
a supporting unit configured for supporting the detecting unit.

2. The heat detecting device according to claim 1, wherein the detecting unit further includes a substrate, and wherein the temperature sensor is disposed under the substrate and facing the heat source.

3. The heat detecting device according to claim 1, wherein the temperature sensor is printed on the detecting unit, and wherein the temperature detecting device further comprises:
a terminal; and
a conductor electrically connecting the temperature sensor and the terminal, the conductor configured to transfer information relating to the heat generated by the heat source from the temperature sensor to the terminal.

4. The heat detecting device according to claim 3, wherein the detecting unit further comprises:
a protection member arranged such that it protects the conductor from the heat generated by the heat source.

5. The heat detecting device according to claim 1, further comprising a heat transferring member in contact with the detecting unit to transfer heat to the temperature sensor.

6. The heat detecting device according to claim 5, wherein a first side of the detecting unit faces the heat source, and wherein the transferring member is connected to a second side of the detecting unit opposite the first side.

7. The heat detecting device according to claim 6 wherein the transferring member and the detecting unit are configured such that heat is indirectly transferred to the temperature sensor through the transferring member.

8. A cooking apparatus comprising:
a heat source;
a plate above the heat source, the plate configured to receive a cooking container; and
a heat detecting unit having a temperature sensor capable of responding to changes in heat generated by the heat source, the temperature sensor arranged such that the heat generated from the heat source is directly transferred from the heat source to the temperature sensor.

9. The cooking apparatus according to claim 8 further comprising a transferring member in contact with the heat detecting unit, the transferring member configured to transfer heat to the temperature sensor of the heat detecting unit.

10. The cooking apparatus according to claim 9, wherein the transferring member is in contact with the plate, and wherein the transferring member and the heat detecting unit are configured such that heat is indirectly transferred from the plate to the temperature sensor through the transferring member.

11. The heating cooking apparatus according to claim 8, further comprising:
a control unit for the heat source, wherein information relating to heat is transmitted from the temperature sensor to the control unit.

12. The cooking apparatus according to claim 11, wherein the control unit comprises:
a processor, wherein the processor is configured to determine temperature based on the information relating to heat transmitted from the temperature sensor to the control unit.

13. The cooking apparatus according to claim 12, wherein the information is based on the heat directly transferred to the temperature sensor from the heat source and based on the heat indirectly transferred to the temperature sensor from the plate through the transferring unit.

14. A method of controlling a cooking appliance that includes a heat source, a cooking surface and a control unit, said method comprising:
detecting a first amount of heat, wherein the first amount of heat is generated by the heat source;
detecting a second amount of heat, wherein the second amount of heat is generated by the cooking surface; and
controlling the heat source based on the detected first and second amounts of heat.

15. The method of claim 14 further comprising:
determining a temperature based on the detected first and second amounts of heat.

16. The method of claim 15, wherein controlling the heat source based on the detected first and second amounts of heat comprises:
controlling the heat source based on the temperature.

17. The method of claim 16, wherein controlling the heat source based on the temperature comprises:
turning off the heat source when the temperature reaches a first predetermined temperature; and
turning on the heat source when the temperature reaches a second predetermined temperature, wherein the first predetermined temperature is greater than the second predetermined temperature.

18. The method of claim 14, wherein the cooking appliance also includes a temperature sensor, and wherein detecting the first amount of heat involves a direct transfer of heat from the heat source to the temperature sensor.

19. The method of claim 14, wherein the cooking appliance also includes a temperature sensor and a cooking surface, and wherein detecting a second amount of heat involves an indirect transfer of heat from the cooking surface to the temperature sensor.

20. A cooking apparatus that includes a heat source, a cooking surface and a control unit, said apparatus comprising:
means for detecting a first amount of heat, wherein the first amount of heat is generated by the heat source;
means for detecting a second amount of heat, wherein the second amount of heat is generated by the cooking surface; and
means for controlling the heat source based on the detected first and second amounts of heat.

21. The cooking apparatus of claim 20 further comprising:
means for determining a temperature based on the detected first and second amounts of heat.

22. The cooking apparatus of claim 21, wherein said means for controlling the heat source based on the detected first and second amounts of heat comprises:
means for controlling the heat source based on the temperature.

23. The cooking apparatus of claim 22, wherein said means for controlling the heat source based on the temperature comprises:
means for turning off the heat source when the temperature reaches a first predetermined temperature; and
means for turning on the heat source when the temperature reaches a second predetermined temperature, wherein the first predetermined temperature is greater than the second predetermined temperature.
